(19) United States
(12) Patent Application Publication
(10) Pub. No.: US 2003/0231218 A1
(43) Pub. Date: Dec. 18, 2003

(54) System and method for indicating the focused control on a graphical user interface

(76) Inventor: Lou Amadio, Sammamish, WA (US)

Correspondence Address: SHOOK, HARDY & BACON, 1200 MAIN STREET, ONE KANSAS CITY PLACE, KANSAS CITY,, MO, 64105-2118, US

(21) Appl. No.: 10/172,254

(22) Filed: Jun. 14, 2002

(51) Int. Cl. G09G 5/00

(52) U.S. Cl. 345/861

(57) ABSTRACT

A method and system for execution in a graphical user interface environment are provided. The method and system are used to indicate the focus condition control to a user of a computer having the graphical user interface. The method includes obtaining data from the control that describes or indicates the focus condition of the control and its location. The focus condition information is used to animate a focus indicator adjacent or around the control to indicate the focus state of the control. If a control gains focus when no other control previously had focus, a focus initiation animation is performed. If focus changes from one control to another, a focus change animation is performed. If focus is lost or destroyed, a focus loss animation may be performed.

### CROSS-REFERENCE TO RELATED APPLICATIONS

None.

### STATEMENT REGARDING FEDERALLY SPONSORED RESEARCH OR DEVELOPMENT

None

### TECHNICAL FIELD

In general, the present invention relates to computer software, and more particularly, to a method and system for indicating the focused control on a graphical user interface within a computer system.

### BACKGROUND OF THE INVENTION

Personal computers (PCs) such as IBM-compatible PCs typically include hardware devices such as a processor and a memory for implementing various software programs, a principal one being a central operating environment. In turn the operating environment, or operating system, supports the variety of other software applications such as a word processing program or a spreadsheet program.

Some operating systems include a graphical user interface (GUI), described generally as a graphical operating system, which displays various information to the user as a combination of pictures and text that the user can manipulate. Generally, some graphical operating systems instigate an instance of a software application by displaying the various text, graphics and features of the application within a rectangular window. This window is generally referred to as a “top-level” window. Typically, within the top-level window are a number of “child” windows, which are subordinate to the top-level or parent window. Some of these windows may be what are known as “controls.” In a graphical user interface, a control is an object on the screen that can be manipulated by the user to perform some action. As an example, a button that is used to select certain options is a control.

Controls can be in one of two states: focused and unfocused. A focused control is a control to which keyboard input will go, if the user types on a keyboard. For example, if an edit control has focus, the keystrokes entered by the user will appear within the edit control. When a control has focus, the control may act on certain keystrokes, and not others. For example, if an “OK” button has focus, the enter key on the keyboard will cause the “OK” control to initiate some action, but other keystrokes will not. It is therefore important for the user to know which, if any, of the controls on the screen currently have focus.

This is difficult for many users in current graphical operating systems. In some systems, the method used to indicate focus can vary from control to control. Moreover, the method used to indicate focus is often ineffective. Examples of current focus indicators include a dotted line surrounding a button, a blinking line within an edit control, a different color within the control or an etched appearance on two sides of the control. The problem with this implementation is that the method for indicating focus changes from one control to another. If the user executes a series of actions on the computer, and focus changes, it may be difficult for the user to determine how focus has changed and which control, if any, currently has focus.

As computers find other uses beyond the standard PC realm, it will remain important for the users to be able to readily determine the focused control. As an example, if a television screen or other monitor is being used as the display, the user may be located a good distance away from the screen. In these instances, it is important to indicate focus to the user in such a way that is more intuitive and consistent than the methods described above.

Therefore, there exists a need to improve the user experience within a graphical operating environment. More specifically, there exists a need to improve the methodology and system used to indicate focus on a display screen.

### BRIEF SUMMARY OF THE INVENTION

The present invention is directed to a method and apparatus for execution in a graphical user interface environment. The apparatus and method are used to convey to the user of the computing device the focus state of a control on the user interface. Data from the control is obtained that indicates whether the control currently has focus. If the control has focus, a focus indicator is animated adjacent the control. If no other control currently had focus and focus is then gained, a focus initiation animation is performed to draw the user's attention to the focused control. If the focus then changes or is lost, the change in focus state is animated.

Additional advantages and novel features of the invention will be set forth in the description which follows, and in part will become apparent to those skilled in the art upon examination of the following, or may be learned from practice of the invention.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIG. 2 is a flow chart illustrating certain aspects of the present invention;

FIG. 3A is a schematic view of a window layout demonstrating an example screen indicating focus on one control;

FIG. 3B is a schematic view of a window layout demonstrating a change in focus from FIG. 3A;

FIG. 3C is a schematic view of a window layout demonstrating an animated change in focus from FIG. 3B; and

FIG. 3D is a schematic view illustrating the end result of the focus change shown in FIG. 3C.

### DETAILED DESCRIPTION OF THE INVENTION

The present invention provides a method and user interface for use in a graphical user interface environment. The invention is used to convey the focus state of a control to the user interface. If the control has focus, a focus indicator is animated adjacent or around the control. Any change in focus state is also animated on the user interface to indicate the state change to the user.

Having briefly described an embodiment of the present invention, an exemplary operating environment for the present invention is described below.

Exemplary Operating Environment

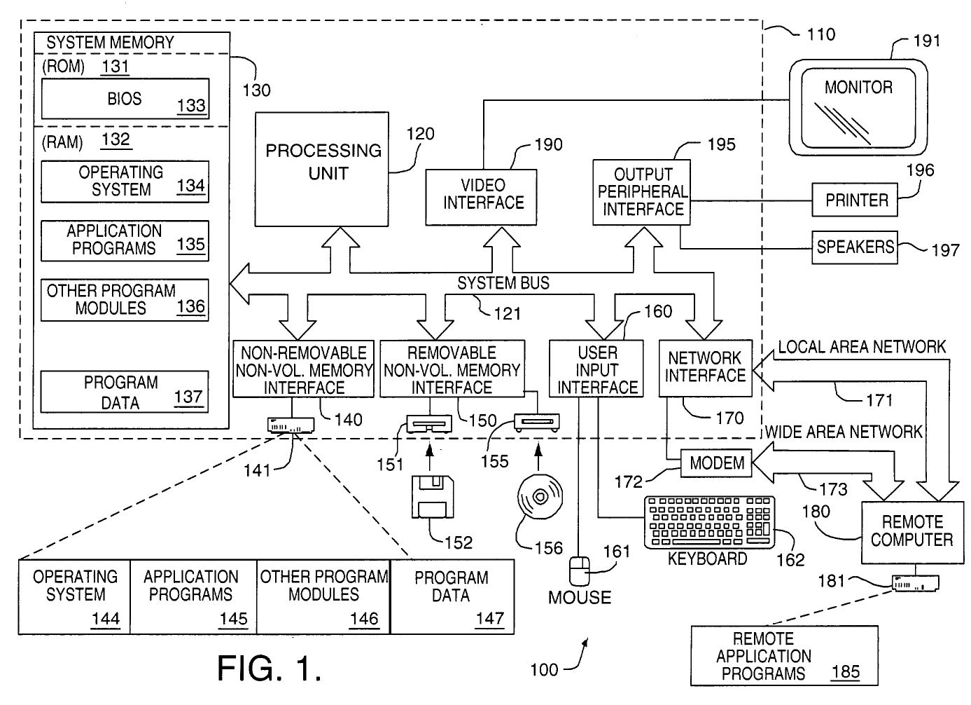

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system 100 for implementing the invention includes a general purpose computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

System and Method for Indicating Focus

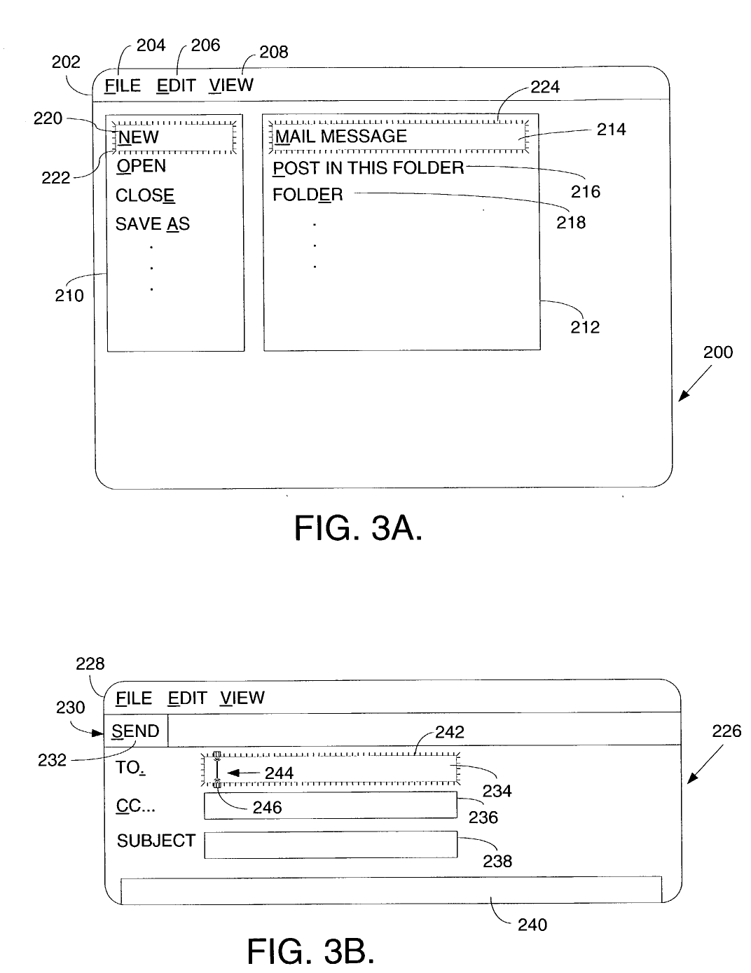

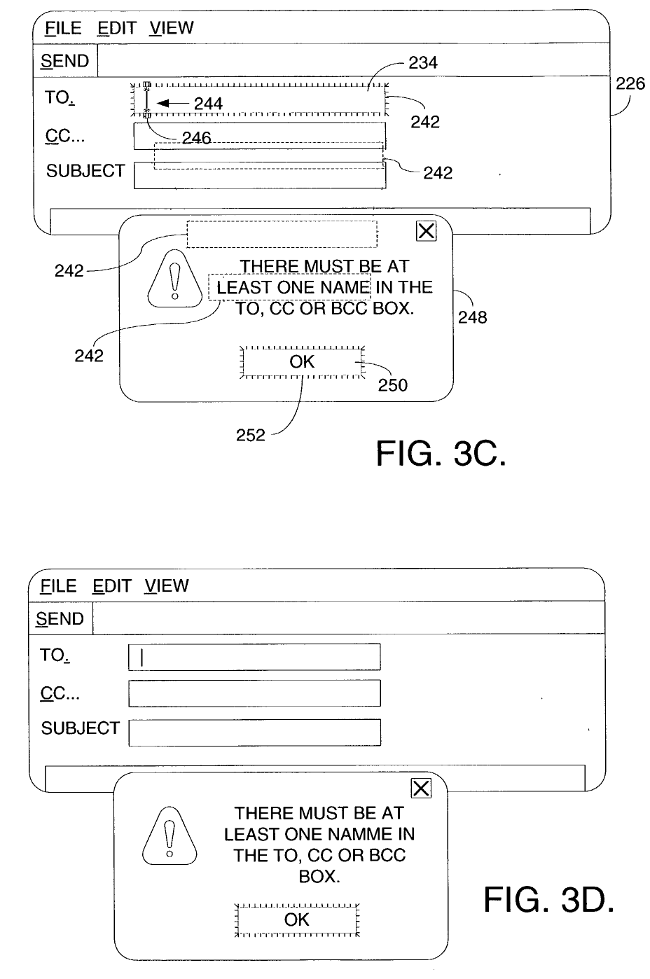

As best seen in FIGS. 3A-3D, a series of schematic screen displays illustrating a change in focus among a number of controls is shown. FIG. 3A illustrates a portion of a window 200 which is representative of a mail manager program, such as MICROSOFT OUTLOOK, from the Microsoft Corporation of Redmond, Wash. The window 200 can occupy all of a user interface display, or a portion thereof. Moreover, the example described below with reference to FIGS. 3A-3D is meant to be illustrative. The invention is in no way limited to the implementation details described in the example. The window 200 shows a portion of the menu bar 202, with the File command 204, the Edit command 206 and the View command 208 being illustrated. Below the menu bar 202 is a drop-down menu 210 associated with the File command 204. Menu 210 is shown with a partial list of commands, such as New, Open, Close and Save As. To the right of menu 210 is another drop-down menu 212 associated with the New command in menu 210. Menu 212 is shown with a partial list of commands, such as “Mail Message” 214, “Post in this Folder” 216 and “Folder” 218.

When a user is navigating within an application, the focus can change from one control to another. As an example, and as seen in FIG. 3A, the user may navigate to the File command 204 on menu bar 202. When the File button 204 is selected, such as with a mouse or other pointing device, the drop-down menu 210 appears. If the user selects the New command in menu 210, the control 220 associated with the New command is given focus. In an embodiment of the present invention, this focus is indicated to the user by performing an initiation animation, if no other control previously had focus. This animation is one that brings the user's attention to the control 220. After the initiation animation, while focus remains on the control 220, a glowing highlight 222 is used to indicate focus to the user. In addition, when the user selects the control 220 in this example, drop-down menu 212 appears to the right of menu 210. As stated above, drop-down menu 212 has a list of commands associated with the New command 220. The user may then select from among the options listed in menu 212. As the user makes a selection, the focus is added to the menu selection. Continuing with the example, if the user selects Mail Message 214, a focus initiation animation is performed for control 214. The focus remains as a glowing highlight 224 surrounding control 214 to indicate the focus to the user. The focus indicator animations referred to throughout this application can be performed in a number of ways. By way of example, and without limitation, the position, size, opacity or color of the focus indicator can be animated.

Again continuing with the above example, if the user selects Mail Message 214, a new window 226 is presented to the user, as shown in FIG. 3B. Window 226 is similar to window 200, in that a menu bar 228 is shown. In addition a portion of the toolbar 230 is shown, illustrating only the Send command 232. Below toolbar 230 is a “To” control 234, a “cc” control 236 and a “Subject” control 238. Beneath the Subject control 238 is a portion of the message area 240. When window 226 is first presented, “To” control 234 initially has focus. The focus is indicated to the user initially with a focus initiation animation, which continues with a glowing highlight 242. In addition, control 234 is an edit control and has an insertion point, or carat 244. To indicate the location of the insertion point 244 to the user, an additional “carat in” animation is performed, resulting in an additional glowing highlight 246. If the user types characters within the control 234, the insertion point 244 will move correspondingly to the right. As the insertion point 246 moves the highlight 246 moves as well to indicate the location of the insertion point 244 to the user.

Continuing with the above example, and with reference to FIG. 3C, a dialog window 248 is shown below window 226. Window 248 is illustrative of a dialog window that may appear if the user selects the “send” button while focus is on control 234 without entering any information within control 234. If this happens, the focus changes from control 234 to an OK button 250. To indicate the change in focus, a focus change animation is performed. The animation transfers the glowing highlighted rectangle 242 from control 234 down to button 250. In this embodiment, the transfer is a continuous animation, but is shown as a series of steps in FIG. 3C. The steps are illustrated by the dotted line rectangles 242 shown in FIG. 3C. As can be seen, the highlighted rectangle 242 changes both location and size to fit about button 250. The resulting focus highlight about button 250 is indicated to the user, as indicated by numeral 252. As shown in FIG. 3D, the highlighting is removed from control 234 and remains with button 250 until the user acts upon the dialog window 248 in some way. The user is thus informed of the focus initially on control 234 with the focus initiation animation and is informed of the change in focus with the focus change animation. Each time focus is indicated to the user in a consistent method so that the user is more likely to recognize the current focus control.

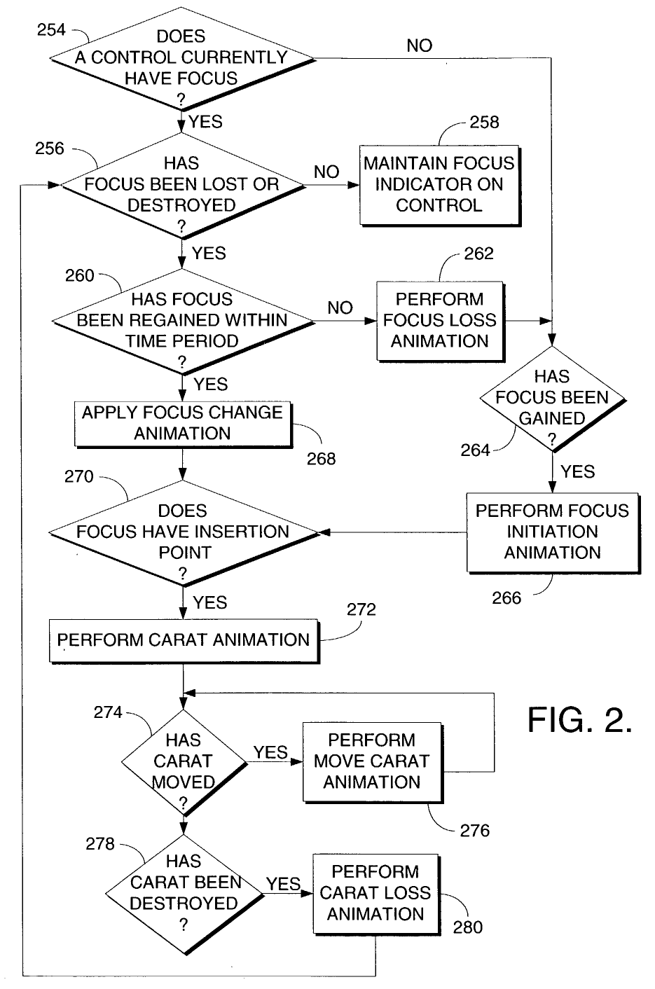

Having described a general example above, the methodology used in the present invention is described below with reference to FIG. 2. The method is preferably implemented within an operating system as discussed more fully below, and begins with a determination of whether a control currently has focus, as shown at 254. If a control currently has focus, the method continues with a monitoring operation 256. In operation 256, the monitoring is for the purpose of determining whether the existing focus has been lost or has been destroyed. If focus has not been lost or destroyed, the focus indicator is maintained on the control having focus, as shown at 258. As shown above with reference to FIGS. 3A-3D, the focus can be a glowing rectangle outlining the control. It should be understood, however, that other ways of indicating focus could be used. If, on the other hand, it is determined that focus has been lost or destroyed, another monitoring process 260 begins to determine whether focus is regained by another control. The monitoring 260 continues for a pre-determined time period. The time period is chosen such that if the focus is migrating from the previous control to another control the monitoring 260 will capture the migration.

If the focus is not regained by another control within the time period, a focus loss animation is performed on the focus indicator associated with the control that lost the focus, as indicated at 262. The focus loss animation can take any of a number of forms. For example, the focus loss animation can slowly dissolve the existing glowing rectangle or can convey an outwardly exploding glowing rectangle that disappears from sight. The focus loss animation would be performed, for example, after the user selected Mail Message 214 in FIG. 3A. It could also be the case that the parent window containing the control that has lost focus is destroyed. In such a case the focus loss animation can be performed quickly, or not at all if the parent window is removed from the screen. After the focus loss animation is performed, the process continues by determining whether focus is later regained by a control, as shown at 264. This determination is the same as if the initial determination at 254 is that no control currently has focus. As long as no control gains focus, the process does nothing other than to continue to monitor for focus gain. If it is determined at 264 that a control has gained focus, a focus initiation animation is performed, as shown at 266. The focus initiation would be performed, for example, when window 226 is presented to the user as shown in FIG. 3B and would indicate the focus on control 234. The focus initiation animation can also take any of a number of forms, which are virtually limitless. For example, the glowing rectangle can initiate as if off the screen and then gradually narrow in to indicate focus about the control. As another example, the glowing rectangle could begin as a line and gradually expand until is surrounds the control.

Returning to monitoring step 260, if it is determined that another control has gained focus, a focus change animation is performed, as shown at 268. The focus change animation transfers the focus indicator from the previous control to the control gaining focus. An example of the focus change animation can be understood with reference to FIG. 3C, where the focus changes from control 234 to control 250. One way to animate this focus change is to continuously animate the glowing rectangle 242 as it moves and resizes to focus indicator 252. As with the other animations discussed above, other animations can be used to indicate the change in focus.

Following steps 266 and 268, the process continues with a determination as to whether the control that has focus also has an insertion point, as indicated at 270. An example of an insertion point can be seen with reference to FIG. 3B in carat 244. If it is determined that the control does have an insertion point, a carat focus creation animation is performed, as shown at 272. The carat focus creation animation can be similar to the focus initiation animation of step 266 or can have a different look. In the example of FIG. 3B, the carat focus animation is an extension of the glowing rectangle 242 as indicated at 246. After it has been determined that an insertion point exists for the control, the method continues by monitoring to determine if the carat has moved, as shown at 274. If the carat moves, a carat move animation is performed, as shown at 276. In the example of FIG. 3B, the carat move animation is simply a move of the extension 246 corresponding to the movement of the carat. In other words, whatever animation is used to indicate focus for the insertion point is moved as the insertion point moves. The method also monitors to determine if the insertion point or carat is destroyed, as shown at 278. If the carat is destroyed, a carat loss animation is performed as shown at 280. The carat loss animation can be similar to the focus loss animation of step 262 or can have a different look. The method then continues in a loop back to step 256.

As noted throughout the discussion above, the animations discussed can take any of a number of forms to indicate that focus has been gained or lost by a control or that focus has changed from one control to another. Similarly the insertion point animations can also take a number of forms. The indication of focus is consistent throughout the user experience. In addition, the change of focus is more readily apparent to the user through the use of animation. Finally, although only visual animations are discussed above, the animations could be accompanied by audio clips to draw the user's attention to the animation taking place.

The information regarding focus is obtained from an existing window manager within the operating system, as known to those of skill in the art. In the WINDOWS family of operating systems from the Microsoft Corporation of Redmond, Wash., the window manager is in the kernel and is accessible using the WIN32 application programming interface. Each application executing on the computer also has a form of window manager. For applications using the WINDOWS operating systems, the window manager is a dynamic link library known as USER32.dll. This client side dynamic link library communicates information to the kernel, which keeps a list of information regarding the controls and their focus state. For example, the information kept in the kernel includes pointers to the currently focused control, if any, where the insertion point is and what top-level windows exist for each application. When focus changes a “setfocus” API is implemented inside the dynamic link library that communicates the change in focus to the kernel, which then changes the pointer to the new focus control.

Inside WIN32 are a set of pointers called WINEVENT hooks. A WINEVENT hook is a generic routing that registers with the kernel. Thereafter, the kernel will inform the application when a specified event happens. For example, a WINEVENT hook can be used to receive notification of a focus change, a window creation, window move or window destroy operation, as well as a carat creation, move or destroy operation. A focus follower application is created that uses the WINEVENT hooks to register for notification of the various control events discussed above. The kernel then informs the focus follower application about events taking place regarding control focus and carat focus. This information is used according to the methodology of FIG. 2 to apply the animations of focus initiation, focus change or focus loss, and/or the animations of carat creation, carat move or carat destroy as discussed above.

As can be understood, the method and system allow a user to more readily ascertain the control that has focus. In addition, any changes in focus are brought to the user's attention through the use of animation, making it more likely that a user will understand the change in focus taking place. The location of the insertion point is also brought to the user's attention, making it more readily noticeable. The focus is thus consistently displayed to the user and is displayed in a way that conveys the focus information in an intuitive manner.

The present invention has been described in relation to particular embodiments, which are intended in all respects to be illustrative rather than restrictive. Alternative embodiments will become apparent to those skilled in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated and with the scope of the claims.

What is claimed is:

1. A computer-implemented method for execution in a graphical user interface environment to indicate the focus condition of a first control, comprising:
obtaining, from the first control, data describing the focus condition of the first control; and
animating a focus indicator for the first control based upon the obtained focus condition of the first control adjacent the first control.

2. A computer-implemented method as recited in claim 1, further comprising:
monitoring the focus status of the first control for a change in focus to a second control; and
animating the focus indicator change from the first control to the second control.

3. A computer-implemented method as recited in claim 2, wherein the focus animation for the second control is located adjacent the second control.

4. A computer-implemented method as recited in claim 2, wherein the animation change from the first control to the second control is continuously visible on the graphical user interface.

5. A computer-implemented method as recited in claim 1, wherein the data describing the focus condition is indicative of a loss of focus condition, and wherein the animating step is an animation indicative of a loss of focus.

6. A computer-implemented method as recited in claim 1, wherein the data describing the focus condition is indicative of a gain in focus condition where no other control currently has focus, and wherein the animating step is an animation indicative of focus creation.

7. A computer system having a processor, a memory and an operating environment, the computer system operable to execute the method as recited in claim 1.

8. A computer-readable medium containing instructions for indicating the focus condition of a first control in a graphical user interface environment, comprising:
obtaining, from the first control, data describing the focus condition of the first control and the outer perimeter of the first control; and
animating and displaying a focus indicator for the first control based upon the obtained focus condition of the first control adjacent the first control.

9. The computer-readable medium of claim 8, further comprising instructions for:
monitoring the focus status of the first control for a change in focus to a second control; and
animating the focus indicator change from the first control to the second control.

10. In a computer system having a computer and a display device, a focus manager implemented in software stored in the computer, comprising:
a focus tracking component that monitors the focus condition of the controls displayed on the display device;
an animation component that animates the area around the control indicated to have focus by the focus tracking component,
whereby the focus condition is brought to the attention of a user viewing the display device.

11. A focus manager as recited in claim 10, wherein the animation component animates a continuous change in focus condition, when a change in focus condition is indicated by the focus tracking component.

12. A focus manager as recited in claim 10, wherein the focus manager is implemented in software stored in the operating system of the computer.

13. A focus manager as recited in claim 10, further comprising an insertion point monitoring component that monitors the existence and location of an insertion point within the control having focus, and wherein the animation component animates an insertion point upon receiving location information regarding the insertion point from the insertion point monitoring component.

14. A focus manager as recited in claim 13, wherein the animation component animates any change in location of the insertion point.

15. A user interface embodied on a computer-readable medium and executable on a computer, comprising:
a first control having focus; and
a first highlighting animation area adjacent the first control, the first highlighting animation area indicative of the focus condition of the first control.

16. A user interface as recited in claim 15, wherein the first control has an insertion point, further comprising an insertion point animation area adjacent the first highlighting animation area and adjacent the insertion point, the insertion point animation area indicative of the location of the insertion point.

17. A user interface as recited in claim 15, further comprising:
a second control, the second control receiving focus from the first control;
a second highlighting animation area adjacent the second control, the second highlighting animation area being displayed after the second control receives focus.

18. A user interface as recited in claim 17, further comprising:
a focus transition area between the first and second control, wherein a transition animation is performed between the first and second controls from the first animation area to the second animation area to indicate a change in focus from the first control to the second control.

19. A user interface as recited in claim 18, wherein the transition animation is continuous.

20. An operating system embodied on a computer-readable medium incorporating the user interface as recited in claim 15.

21. A computer system comprising a central processing unit and memory, the computer system including a graphical user interface which includes a first control having focus and a first highlighting animation area adjacent the first control, the first highlighting animation area indicative of the focus condition of the first control.

22. A computer system as recited in claim 21, wherein the first control has an insertion point, further comprising an insertion point animation area adjacent the first highlighting animation area and adjacent the insertion point, the insertion point animation area indicative of the location of the insertion point.

23. A computer system as recited in claim 22, further comprising:
a second control, the second control receiving focus from the first control;
a second highlighting animation area adjacent the second control, the second highlighting animation area being displayed after the second control receives focus.

24. A computer system as recited in claim 23, further comprising:
a focus transition area between the first and second control, wherein a transition animation is performed between the first and second controls from the first animation area to the second animation area to indicate a change in focus from the first control to the second control.

25. A computer-implemented method for execution in a graphical user interface environment to indicate the focus condition of one or more controls, comprising:
obtaining, from a first control, data describing the focus condition of the first control;
animating a focus indicator for the first control based upon the obtained focus condition of the first control adjacent the first control;
monitoring the focus status of the first control for a change in focus to a second control; and
animating the focus indicator change from the first control to the second control.

26. A computer-implemented method as recited in claim 25, wherein the animation change from the first control to the second control is a continuous animation.

27. A computer-implemented method as recited in claim 26, wherein the animation change from the first control to the second control includes changing the color of the focus indicator.

28. A computer-readable medium containing instructions for indicating the focus condition of one or more controls in a graphical user interface environment, comprising:
obtaining, from a first control, data describing the focus condition of the first control and the outer perimeter of the first control;
animating and displaying a focus indicator for the first control based upon the obtained focus condition of the first control adjacent the first control;
monitoring the focus status of the first control for a change in focus to a second control; and
animating the focus indicator change from the first control to the second control.

29. A computer-readable medium as recited in claim 28, wherein the instructions for the animation change from the first control to the second control include instructions for a continuous animation.

30. A computer-readable medium as recited in claim 29, wherein the instructions for the animation change from the first control to the second control include instructions for changing the color of the focus indicator.
